(19) United States
(12) Patent Application Publication
(10) Pub. No.: US 2016/0306814 A1
(43) Pub. Date: Oct. 20, 2016

(54) SHIP LOCATION DISPLAY SYSTEM

(71) Applicant: Commodity Flow Limited, London (GB)

(72) Inventors: John Paskin, Richmond (GB); Stuart Reed, Cheltenham (GB)

(73) Assignee: Commodity Flow Limited, London (GB)

(21) Appl. No.: 15/103,063

(22) PCT Filed: Dec. 10, 2013
(86) PCT No.: PCT/GB2013/053250

§ 371 Date: Jun. 9, 2016

(51) Int. Cl. G06F 17/30; H04L 29/06

(52) U.S. Cl. CPC G06F 17/3087; G06F 17/30241; H04L 69/04; G06F 17/30554

(57) ABSTRACT

A method for displaying ship locations on a map is disclosed. The method comprises generating a database query for ship locations requested in a data request received from a client device via a network and retrieving results of the query from a location database using the generated database query, the results including the requested ship locations. The location database contains a plurality of records and each record includes at least information identifying a ship and a location of the ship. The method also includes packaging the results of the query in one of Keyhole Markup Language (KML), compressed KML (KMZ) and bitmap format and sending the packaged results of the query to the client device. A system for displaying ship locations on a map is also disclosed.

The invention relates to a system and method for displaying locations of ships to a user.

Commercial ships weighing more than 300 tonnes are fitted with Automatic Identification System (AIS) transceivers, which allow the location of each ship to be tracked by vessel traffic services. Vessels fitted with AIS transceivers can be identified and tracked by AIS base stations located along coast lines or by satellites. Data on the locations of ships around the world is collected using the AIS and stored in commercial databases.

Due to the large number of ships fitted with AIS in service and the fact that each ship's location may be recorded as more than a hundred times per day, the volume of data on historical locations of ships recorded via AIS in the commercial databases is extremely large. The volume of data makes it time consuming to access a database of historical location data, filter for a desired group of ships and/or time period and then display the complete set of historical results. Using existing internet browser-based systems, it could take several minutes to display a map of the locations of the ships belonging to a large trading company over a period of a year for example. This type of map would be useful for traders and analysts, for whom such a long delay in obtaining the results would be unacceptable. Due to the time taken to render such maps, only maps having smaller numbers of ship locations marked on them are typically accessed with current systems on an on-demand or real-time basis.

According to a first aspect of the invention, there is provided a method for displaying ship locations on a map as defined in claim 1.

The inventors have found that the time taken to render a map of multiple ship locations retrieved from a database can be significantly shortened by rendering the map using Keyhole Markup Language (KML) format or bitmap format. In current internet browser systems, maps of ship locations are rendered using application programming interfaces (APIs) for geographic information systems (GIS) such as Google Maps (RTM) or Bing Maps (RTM). KML provides less information in the rendered map than the conventional APIs but is much quicker to render the volumes of data required to present historical data on ship locations for the numbers of ships included in a typical AIS database query.

According to a second aspect of the invention, there is provided a method for displaying ship locations on a map as defined in claim 5.

Since users often want to obtain more information on each ship having a location shown on the map, it is still advantageous to use an API to render the map when fewer ship locations are to be included (for example when only showing current ship positions on a map). KML or bitmap format can then be used to render the map only when the number of ship locations included would cause a significant delay when rendering using an API. The threshold for the data volume of the results of the query can be set based on the time delay that the volume of data corresponding to the threshold would typically cause in rendering the results. For example, the threshold can be set at a level that would cause a delay of thirty seconds in rendering the results at the client system. The threshold can also be set at a fixed number of ship locations, such as the results containing a hundred thousand locations.

According to a third aspect of the invention, there is provided a system for displaying ship locations on a map as defined in claim 6.

Embodiments of the present invention will now be described by way of further example only and with reference to the accompanying drawings, in which:

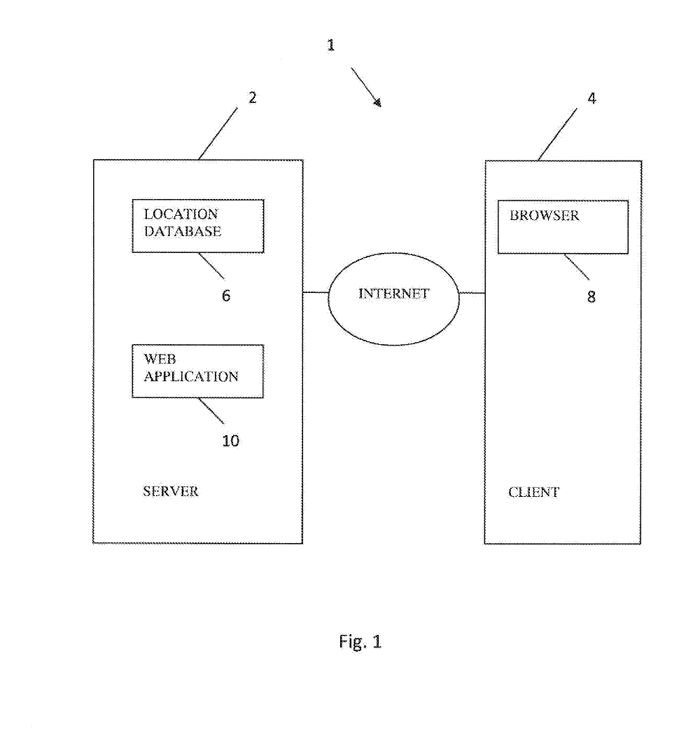

FIG. 1 shows a system for displaying ship locations according to an embodiment of the invention;

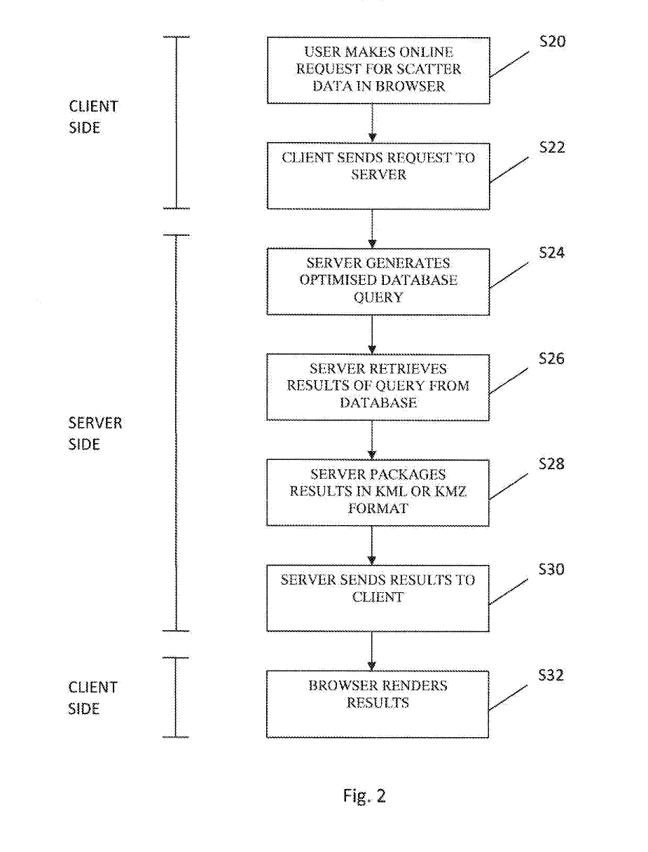

FIG. 2 is a flow diagram illustrating a method for displaying ship locations according to a first embodiment of the invention;

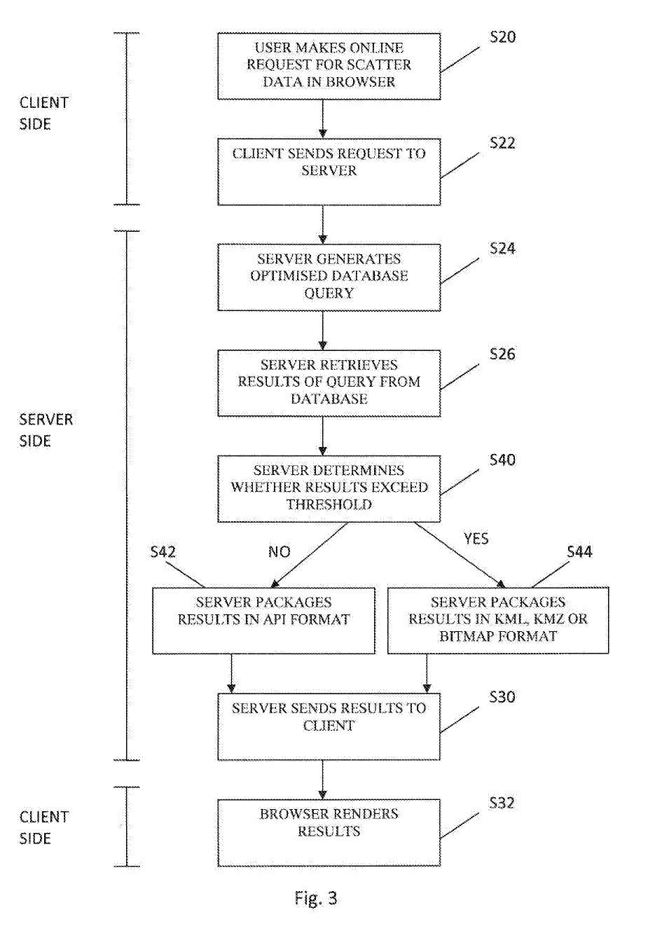

FIG. 3 is a flow diagram illustrating a method for displaying ship locations according to an alternative embodiment of the invention; and

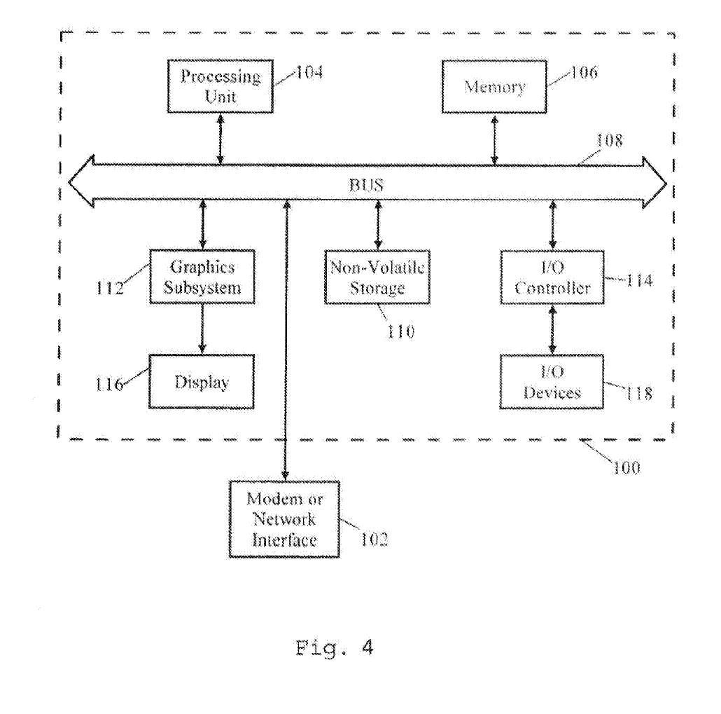

FIG. 4 illustrates an exemplary embodiment of a computer system in which the system and method of the present invention may be realised.

As shown in FIG. 1, a system 1 according to a first embodiment of the invention includes a server 2 and a client 4 connected by a network such as the internet. The server 2 includes a location database 6 storing AIS data for ships. Each AIS record in the database 6 includes the identity of the ship, its location (i.e. GPS coordinates) and a time and date. The record also includes which company the ship is owned by. Typically, a database 6 used in the present invention would have at least 100 million such records, although the invention is suitable for use with any size of database. The server 2 itself is typically a general purpose computer connected to the internet as is well known in the art.

The server 2 also includes a web application 10. The web application 10 has a user interface and is an application for one of several well known browser-based mapping GIS tools such as Google Maps®, Bing Maps® and OpenStreetMap®. The web application 10 is able to access the database 6, either because the application 10 runs on the server 2 storing the database 6 or because the application 10 is connected to the database 6 via a network. Although the web application 10 is shown within the server 2 hosting the location database 6 in this embodiment, the web application 10 could equally be provided on a separate server connected to the server 2 via a network such as the internet. The physical locations of the components of the system 1 are not important to the invention and should not be construed as limiting, as is well known to one skilled in the art.

The client 4 includes a browser 8. The client 4 is also a general purpose computer connected to the internet and the browser 8 may be any known browser such as Internet Explorer® or Google Chrome®. The browser 8 is used to access a web application 10 performing the method of the invention.

The method of the invention is illustrated in FIG. 2. Upon accessing the web application 10 of the invention via the browser 8, the web application 10 gives a user the option of submitting a request for scatter data at step S20. Scatter data is AIS location data for one or more ships over a period of time represented as a series of points on a map. The request may include search filters such as one or more names of ship owners, particular types of ships, a defined time interval and/or a set of geographical areas. For example, the user may submit a request for scatter data on all ships belonging to company X over the last year via the web application 10.

The client 4 sends the user's data request to the server 2 at step S22 via a network such as the internet. On receiving the request, the server 2 and specifically the web application 10 generates an optimised database query at step S24. The database query is optimised using data warehousing and de-normalisation for the specific type of user request described above, which allows the results of the query to be retrieved from the location database 6 more quickly than would be possible using a non-optimised database query. The database query is for the ship locations requested in the user's scatter data request. For example, the database query may be for the requested ship locations “locations of all ships of type Y belonging to company Z between July 2011 and April 2012”.

Once the optimised database query has been generated, the server 2 uses it to retrieve the results of the query from the database 6 at step S26. The server 2 then packages the results in KML or KMZ (i.e. compressed KML) format at step S28 so that they can be sent back to the user. The results packaged in KML format take up a much smaller volume of data than they would if the results were packaged using the API of the GIS tool, e.g. Google Maps API. The server 2 sends the results to the client 4 via the internet at step S30.

Finally, the browser 8 renders the results received from the server 2 at step S32. Since the results are received in KML/KMZ format, the browser 8 can render the results much more quickly than would be possible with results received in the GIS API format. For example, it can take several minutes to render results for a large volume of scatter data in a GIS API format, whereas the same volume of scatter data can be rendered in a few seconds using the present invention.

In the rendering step, the browser 8 displays the locations of the ships retrieved from the location database 6 as points on a map. This allows a user to visualise quickly information such as historical ship patterns for ship owners, trading patterns for types of ship (e.g. LNG ships or large crude carriers) across the globe, flows of ships from a particular port or jetty and detailed shipping movements within a port or region. It is commercially valuable for a user to be able to access such information based on actual AIS ship observations in less than a minute rather than having to look at smaller groups of ships or areas, or wait for several minutes to see results.

The web application 10 has been described above as using the KML/KMZ formats to render scatter data. However, the server 2 can alternatively package the results of the user's request as bitmap data at step S28, which can then be rendered by the browser 8. Since bitmap data does not include any additional information beyond an image of the map showing the ship locations, it takes up a smaller volume of data even than KML and is even quicker to render at the browser 8. However, this comes at the cost of the ability to manipulate the ship location data on the client 4 side as such an approach is constrained in the amount of data which can be associated with the image.

A method of an alternative embodiment of the invention is shown in FIG. 3. In the above embodiment, the web application 10 has been described as always using KML, KMZ or bitmap formats to render scatter data. However, in an alternative embodiment the application 10 decides whether to render scatter data using KML/KMZ/bitmap format or a conventional API format depending on the volume of data in the results of the query retrieved from the location database 6. In this embodiment, a predetermined threshold for the volume of data in the results is stored in the web application 10. For example, this threshold may be the equivalent of 100,000 AIS records retrieved from the database 6.

This embodiment differs from the first embodiment in that the web application 10 performs an additional step S40 of comparing the volume of data in the results retrieved from the database 6 to the threshold. If the web application 10 determines that the volume of data exceeds the threshold then it renders the results of the query using KML/KMZ/bitmap format at step S44. If the web application 10 determines that the volume of data does not exceed the threshold then it renders the results of the query using the API format appropriate to the web application 10, for example Google Maps API, at step S42. Otherwise, the method is the same as that in the first embodiment described above.

FIG. 4 illustrates an exemplary embodiment of a computer system 100 in which the system 1 and method of the present invention may be realised. In particular, the server 2 and the client 4 in the embodiment described above may be implemented as the computer system 100.

The computer system 100 may interface to external systems through a fixed wire or wireless connection or any other network interface 102 such as analog or ISDN modems, cable modems (ADSL/DSL), Ethernet or fibre optic interfaces, cellular or HSDS services and satellite transmission interfaces. As shown in FIG. 4, the computer system 100 includes a processing unit 104, which may be a conventional microprocessor, such as an Intel Core microprocessor or an ARM Cortex microprocessor, which are known to one of ordinary skill in the computer art.

System memory 106 is coupled to the processing unit 104 by a system bus 108. System memory 106 may be a DRAM, RAM, static RAM (SRAM) or any combination thereof. Bus 108 couples processing unit 104 to system memory 106, to non-volatile storage 110, to graphics subsystem 112 and to input/output (I/O) controller 114. Graphics subsystem 112 controls a display device 116, for example a liquid crystal display, which may be part of the graphics subsystem 112. The scatter data rendered by the browser 8 above may be displayed on the display device 116. The I/O devices 118 coupled to I/O controller 114 may include one or more of a keyboard, tablet, stylus, disk drives, printers, a mouse, a touch screen or other gesture driven interface and the like as known to one of ordinary skill in the computer art. The user's request above may be entered via the I/O devices.

The non-volatile storage 110 may be a magnetic hard disk, a flash memory or another form of storage for large amounts of data. Some of this data is often written by a direct memory access process into the system memory 106 during execution of the software in the computer system 100 such as the browser 8. The non-volatile storage 110 may contain the location database 6 and the web application 10 of the server 2 above and the browser 8 of the client 4 above.

The foregoing description has been given by way of example only and it will be appreciated by a person skilled in the art that modifications can be made without departing from the scope of the present invention.

1. A method for displaying ship locations on a map, the method comprising:
generating a database query for ship locations requested in a data request received from a client device via a network;
retrieving results of the query from a location database using the generated database query, the results including the requested ship locations, wherein the location database contains a plurality of records and each record includes at least information identifying a ship and a location of the ship;
packaging the results of the query in one of Keyhole Markup Language (KML), compressed KML (KMZ) and bitmap format; and
sending the packaged results of the query to the client device.

2. The method according to claim 1, wherein the location database contains Automatic Identification System (AIS) location records.

3. The method according to claim 1, wherein the method is performed by a web application.

4. The method according to claim 3, wherein the web application is an application for a browser-based mapping geographical information system (GIS) tool.

5. A method for displaying ship locations on a map, the method comprising:
generating a database query for ship locations requested in a data request received from a client device via a network;
retrieving results of the query from a location database using the generated database query, the results including the requested ship locations, wherein the location database contains a plurality of records and each record includes at least information identifying a ship and a location of the ship;
determining whether the data volume of the results of the query exceeds a predetermined threshold;
if the data volume of the results of the query exceeds the predetermined threshold, packaging the results of the query in one of Keyhole Markup Language (KML), compressed KML (KMZ) and bitmap format;
if the data volume of the results of the query does not exceed the predetermined threshold, packaging the results of the query in a geographical information system (GIS) application programming interface (API) format; and
sending the packaged results of the query to the client device.

6. A system for displaying ship locations on a map, comprising:
a location database containing a plurality of records, each record including at least information identifying a ship and a location of the ship; and
an application adapted to access the location database;
wherein the application is adapted to:
receive a data request from a client device via a network;
generate a database query for ship locations requested in the data request;
retrieve results of the query from the location database using the generated database query, the results including the requested ship locations;
package the results of the query in one of Keyhole Markup Language (KML), compressed KML (KMZ) and bitmap format; and
send the packaged results of the query to the client device via the network.

7. The system according to claim 6, wherein the application is a web application.

8. The system according to claim 7, wherein the web application is an application for a browser-based mapping geographical information system (GIS) tool.

9. The system of claim 6 further comprising the client device, wherein the client device is adapted to:
generate the data request based on information entered into the client device by a user;
send the data request to the application via the network;
receive the packaged results of the query from the application via the network; and
render the packaged results of the query as a map to be viewed by the user.

10. The system of claim 9, wherein the client device includes a browser and the browser is adapted to generate the data request and render the packaged results of the query.
